(19) United States
(12) Patent Application Publication
(10) Pub. No.: US 2014/0375675 A1
(43) Pub. Date: Dec. 25, 2014

(54) IMAGE OUTPUT APPARATUS AND DISPLAY DEVICE

(71) Applicant: Funai Electric Co., Ltd., Daito, Osaka (JP)

(72) Inventors: Hidetoshi Ishihara, Daito (JP); Keisuke Tsukamoto, Daito (JP); Kentaro Eto, Daito (JP); Keita Nishimura, Daito (JP); Norihiro Higashi, Daito (JP)

(21) Appl. No.: 14/362,970

(22) PCT Filed: Nov. 13, 2012
(86) PCT No.: PCT/IB2012/002328

§ 371 Date: Jun. 5, 2014

(30) Foreign Application Priority Data
Dec. 27, 2011 (JP) 2011-284760

(51) Int. Cl. G09G 5/06

(52) U.S. Cl. CPC G09G 5/06
USPC 345/601

(57) ABSTRACT

An image output apparatus includes an image processing component, an OSD production component and an output component. The image processing component is configured to perform an image processing on input image data to generate processed image data. The OSD production component is configured to produce OSD data that specifies color data according to a display characteristic of a display apparatus that is configured to be connected to the image output apparatus. The output component is configured to combine the OSD data with the processed image data to output output image data.

### CROSS-REFERENCE TO RELATED APPLICATIONS

This application claims priority to Japanese Patent Application No, 2011-284760 filed on Dec. 27, 2011. The entire disclosure of Japanese Patent Application No. 2011-284760 is hereby incorporated herein by reference.

### BACKGROUND

1. Field of the Invention

The present invention generally relates to an image output apparatus and a display device. More specifically, the present invention relates to an image output apparatus and a display device with which an OSD image can be displayed.

2. Background Information

Input image data acquired by an apparatus has preset gradation values and so forth, irrespective of the characteristics of a target device to which the data will be outputted. Thus, this input image data has to be corrected by taking the characteristics of the target device into account. There is a known apparatus that outputs after correcting the input image data according to the display characteristics of the target device (see Japanese Laid-Open Patent Application Publication No. 2006-208575, for example). On the other hand, there is also a known device that outputs image data after combining an OSD image (on-screen display image) with input image data (see Japanese Laid-Open Patent Application Publication No. 2003-504989, for example).

### SUMMARY

It has been discovered that, with the conventional device in which the input image data is subjected to specific image quality adjustment and then combined with the OSD image, since the OSD image does not undergo the image quality adjustment, the OSD image does not have a consistent appearance, due to display characteristics of this device to which the data is outputted.

One object of the present disclosure is to provide an image output apparatus and a display device with which consistent color can be achieved in an OSD image.

In view of the state of the know technology, an image output apparatus includes an image processing component, an OSD production component and an output component. The image processing component is configured to perform an image processing on input image data to generate processed image data. The OSD production component configured to produce OSD data that specifies color data according to a display characteristic of a display apparatus that is configured to be connected to the image output apparatus. The output component is configured to combine the OSD data with the processed image data to output output image data.

Other objects, features, aspects and advantages of the present disclosure will become apparent to those skilled in the art from the following detailed description, which, taken in conjunction with the annexed drawings, discloses selected embodiments of image output apparatus and a display device.

### BRIEF DESCRIPTION OF THE DRAWINGS

Referring now to the attached drawings which form a part of this original disclosure:

FIG. 1 is a block diagram of a display device in accordance with a first embodiment;

FIG. 2 is a flowchart illustrating image output processing of the display device illustrated in FIG. 1;

FIG. 3A is a diagram of an OSD image displayed by the display device illustrated in FIG. 1;

FIG. 3B is an enlarged diagram of the OSD image displayed by the display device, illustrating bitmap data forming the OSD image;

FIG. 4 is a diagram illustrating relationship between data and tables stored in memories of the display device illustrated in FIG. 1;

FIG. 5 is a flowchart illustrating adjustment parameter setting processing of the display device illustrated in FIG. 1;

FIG. 6 is a diagram illustrating a panel code list recorded to a controller of the display device illustrated in FIG. 1;

FIG. 7 is a block diagram of an image output apparatus in accordance with a second embodiment; and

FIG. 8 is a flowchart illustrating adjustment parameter setting processing of the image output apparatus illustrated in FIG. 7.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

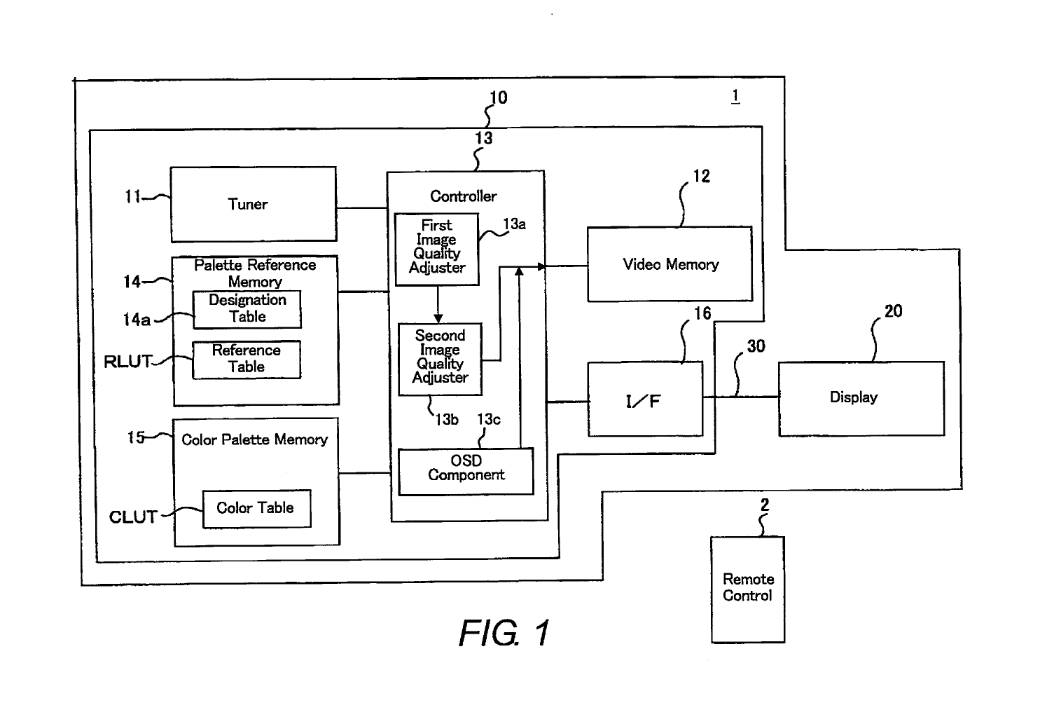

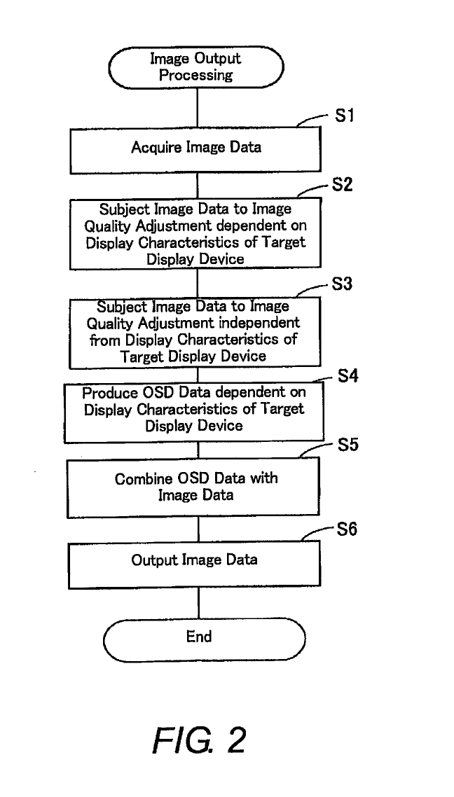

Referring to FIGS. 1 to 6, a display device 1 (e.g., image display device) is illustrated in accordance with a first embodiment. FIG. 1 is a block diagram of the display device 1. FIG. 2 is a flowchart illustrating image output processing of the display device 1.

As shown in FIG. 1, the display device I includes a digital board 10 (e.g., an image output apparatus) and a display 20 (e.g., a display component or display apparatus). The digital board 10 is electrically connected to an antenna on an input side, and is electrically connected to the display 20 on an output side via an LVDS cable 30. In this configuration, the digital board 10 extracts video data pertaining to a specific channel from a television broadcast received by a tuner 11, subjects this video data to specific processing (e.g., an image processing), and then outputs it through the LVDS cable 30 to the display 20.

The display 20 is a liquid crystal display, for example. However, the display 20 can be any type of displays. The display 20 includes a display main body and a driver. The display main body is made up of a plurality of pixels of R (red), G (green), and B (blue) according to the resolution. The driver subjects the video data received through the LVDS cable 30 to digital-analog conversion, and produces a drive voltage for driving the pixels. The pixels and the driver are connected by wiring, and the drive voltage is supplied through this wiring to the pixels.

The digital board 10 includes the tuner 11, a video memory 12, a controller 13, a palette reference memory 14, a color palette memory 15, and an interface 16. The tuner 11, the video memory 12, the controller 13, and the interface 16 are electrically connected via a bus (such as an I2C bus) and are able to communicate with each other.

The controller 13 includes a CPU (central processing unit), a ROM (read-only memory) for recording specific firmware or the like, a RAM (random access memory), and so on. The controller 13 performs overall control of the drive of the display device 1 by executing firmware and the like recorded to the ROM, and also performs the image output processing shown in FIG. 2. The controller 13 can also include other conventional components such as an input interface circuit, and an output interface circuit. The CPU of the controller 13 is programmed to control the operation of the display device 1. The ROM and RAM store processing results and control programs such as ones for controlling the display device 1 that are run by the CPU. The RAM also stores statuses of operational flags and various control data. The ROM stores the control programs for various operations. The controller 13 is capable of selectively controlling any of the components connected thereto in accordance with the control program. It will be apparent to those skilled in the art from this disclosure that the precise structure and algorithms for the controller 13 can be any combination of hardware and software that will carry out the functions of the present application. Furthermore, the palette reference memory 14 and the color palette memory 15 can include any memory circuits suitable for storing tables, such as a ROM device, a RAM device and so forth.

In the image output processing shown in FIG. 2, the controller 13 functions as a first image quality adjuster (e.g., image quality adjustment means or an image processing component) 13a, a second image quality adjuster 13b, and an OSD component (e.g., OSD production means or an OSD production component) 13c. This image output processing results in the output of image data alone, or this image data combined with OSD data, to the display 20.

In step S1 in FIG. 2, the controller 13 acquires image data. That is, the controller 13 acquires image data pertaining to a specific channel extracted by the tuner 11, and records this data to the video memory 12.

Then, in step S2, the controller 13 subjects the image data recorded to the video memory 12 to image quality adjustment under the function of the first image quality adjuster 13a. As a function of the first image quality adjuster 13a, the controller 13 subjects the various kinds of image data recorded to the video memory 12 to image quality adjustment depending on the display characteristics of the display 20 to which the data will be outputted. More specifically, the first image quality adjuster 13a performs resolution conversion processing (e.g., an image quality processing or an image processing) on the image data according to the resolution of the display 20, and performs gamma correction (e.g., an image quality processing or an image processing) according to the display characteristics of the display 20.

The gamma correction referred to here involves converting the gradation value of non-device-specific image data (hereinafter also referred to as input image data) into the gradation value of image data that is dependent on the display characteristics of the display 20 (hereinafter also referred to as processed image data (or output image data)). More specifically, the relation between the input and output values can be shown as a gamma curve (e.g., a gamma characteristic) by plotting the gradation value of the input image data on the horizontal axis and the gradation value of the processed image data on the vertical axis. Therefore, gamma correction makes the corresponding relation between the input image data and processed image data dependent on the display characteristics of the display 20 consistent between different display devices by varying the value of the processed image data. Also, the display characteristics of the display 20 are determined according to an option code P_ON (discussed below), and various parameters are set according to this option code P_ON.

Next, in step S3, the controller 13 subjects the processed image data to the image quality adjustment under the function of the second image quality adjuster 13b. As the function of the second image quality adjuster 13b, the controller 13 subjects the processed image data to the image quality adjustment that does not depend on the display characteristics of the target display 20. For example, the second image quality adjuster 13b subjects the processed image data to contrast adjustment, brightness adjustment, and so forth to obtain further processed image data. Here, the contrast adjustment, brightness adjustment, and so forth performed by the second image quality adjuster 13b are different from what is performed by the first image quality adjuster 13a in a configuration in which parameters are set according to user interface input.

Then, in step S4, the controller 13 produces OSD data under the function of the OSD component 13c. As the function of the OSD component 13c, the controller 13 produces the OSD data for displaying an OSD image, and combines this OSD data with the image data (i.e., the further processed image data from the second image quality adjuster 13b). The values for the OSD data produced by the OSD component 13c are set according to the display characteristics of the display 20. Of course, the controller 13 can produce the OSD data for displaying the OSD image, and combine this OSD data with the processed image data from the first image quality adjuster 13a.

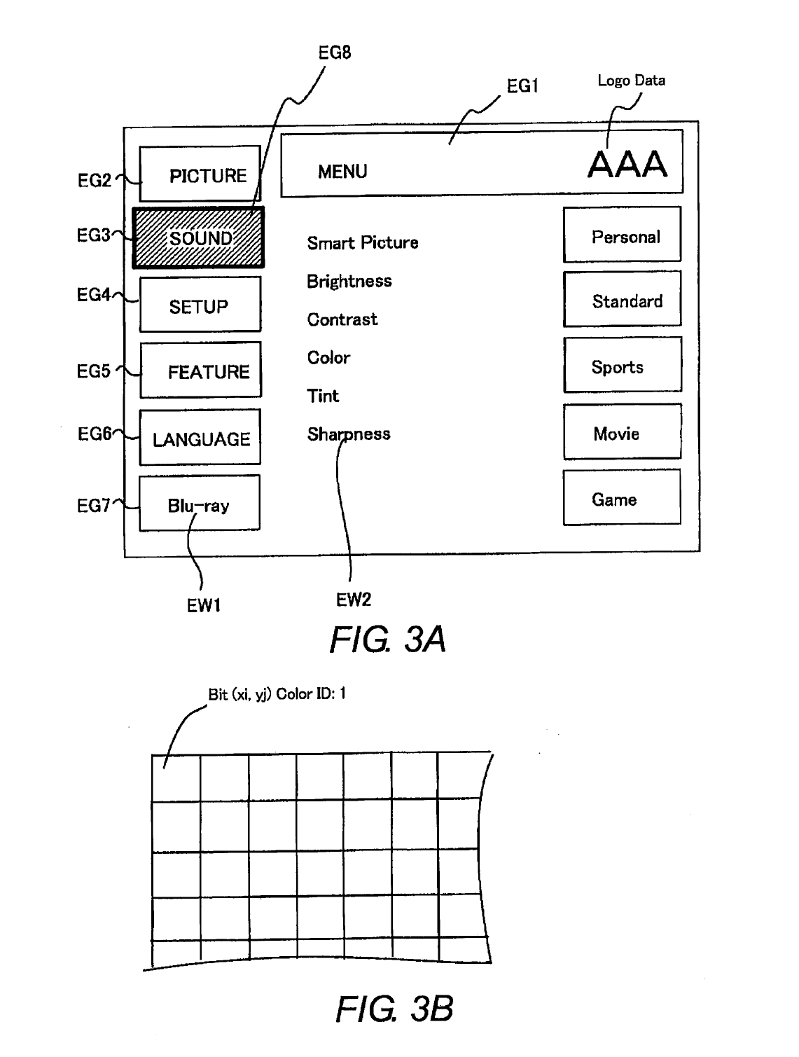

The OSD image is an image that is displayed on the screen when the user operates a specific key on the remote control 2 or the like. An example of the OSD image is shown in FIG. 3A. Specifically, the OSD image includes a banner image EG1 that decorates this OSD image, a plurality of icon boxes EGN (where N is an integer from 2 to 7) labeled with the character string EW1 for making various kinds of settings for “PICTURE,” “SOUND,” “SETUP,” “FEATURE,” “LANGUAGE,” and “Blu-ray” (Blu-ray is a registered trademark), a cursor EG8 that is displayed in an inverted color when the various icons are selected, and other character strings EW2. Also, a logo image (e.g., logo data) indicating the brand of the display device 1 is displayed in the banner image EG1. In the illustrated embodiment, the various components that make up the OSD image will also be called “constituent elements”.

FIG. 3B is an enlarged diagram of a part of the OSD image shown in FIG. 3A. As shown in FIG. 3B, the OSD data is made up of bitmap data in which a specific number of bits or pixels are arranged in the x and y directions (e.g., horizontal and vertical directions). Color data is specified for each of the bits (xi, yj) that make up the bitmap data from among 256 colors selected from among 1024 colors. Also, of the various bits, the bits that make up the above-mentioned constituent elements are also called frame data. For example, the banner image EG1 is constituted by imparting specific color data to the frame data, which is a grouping of bits that make up this image. Here, “color data” means a color reproduced by mixing the R, G, and B color elements, or a color reproduced by just one of the R, G, and B color elements.

In this embodiment, the color of the OSD image is made consistent between different displays by designating the color data that takes into account the gamma curve of the display 20 for the frame data. For example, for bits that are supposed to express a gradation of “100” in the OSD image, the gradation value of the color data outputted as a gradation value of “100” is designated according to the gamma curve of the display 20.

Color IDs associated with the bits are used as the method by which the OSD component 13c designates the color data for the frame data. The color IDs are associated with whichever color data is recorded to a color table CLUT (discussed below). Therefore, the color of a specific bit is designated by the color ID assigned to that bit.

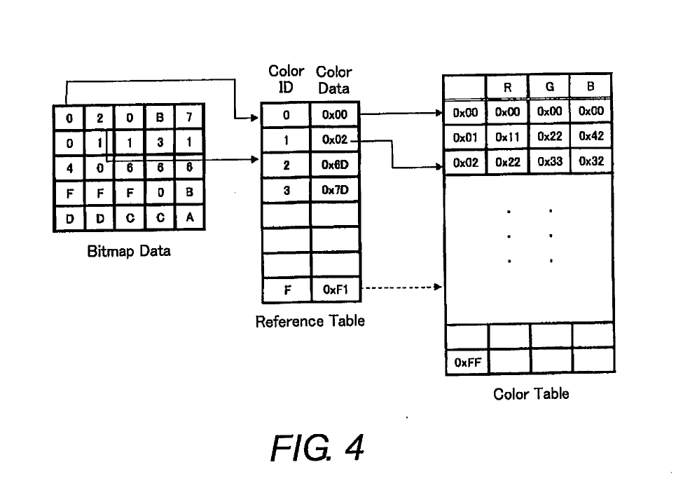

Next, to describe the production of the OSD data, a reference table RLUT and the color table CLUT will be described. FIG. 4 is a diagram illustrating relationship between the reference table RLUT and the color table CLUT. The Color IDs associated with the various bits, and the color data recorded in any color table CLUT are recorded to the reference table RLUT and associated on a one-to-one basis. The arrangement of the various color data is stipulated for arrangement order according to the gradation value of the R, G, and B color elements.

8-bit color data (i.e., 256 colors) selected ahead of time from among 10-bit color data (i.e., 1024 colors) is recorded in a specific arrangement (e.g., 256 rows of 0 to 255 in FIG. 4) to the color table CLUT. Also, gradation values for each of the R, G, and B colors that will be the color elements of this color data are recorded and associated with each set of color data. The sets of color data recorded to the color table CLUT are arranged in the order of the gradation values of R, G, and B that become the color elements.

For example, as shown in FIG. 4, the color data for the 256 colors of the color data selected from among 1024 colors of the color data is recorded to the color table CLUT. In other words, the color data of the color table CLUT is indicative of the colors (e.g., a part of colors) whose number (e.g., 256) is less than maximum number (e.g., 1024) of gradations reproduced by the display 20. Each of the color IDs corresponds to each set of the color data for the 256 colors recorded to the color table CLUT. In this embodiment, the color IDs are set for each bit. However, each of the constituent elements can instead serve as a unit for which a color ID is set. In the illustrated embodiment, the color table CLUT forms a color data group of the present application.

A plurality of reference tables RLUT are recorded to the palette reference memory 14 according to the number of option codes P_ON (discussed below). Similarly, a plurality of color tables CLUT are recorded to the color palette memory 15 according to the number of option codes P_ON (discussed below). Each of the color tables CLUT stores the color data corresponding to the display characteristics of the display 20, which is identified according to the option code P_ON. Therefore, the palette reference memory 14 and the color palette memory 15 form recording means or a memory component of the present application. Furthermore, the ODS component 13c can store the frame data that forms the OSD data. Thus, the OSD component 13c also forms recording means or a memory component of the present application. The frame data includes a color ID associated with each pixel forming the frame data. Moreover, the reference table RLUT associates the color ID with the color data according to the display characteristic of the display 20.

In step S5 in FIG. 2, the controller 13 combines the OSD data with the image data (e.g., the processed image data) that has undergone image quality adjustment. Therefore, the OSD data shown in FIG. 3A, for example, is combined with a partial region of the image data.

In step S6, the controller 13 outputs the combined image data (e.g., output image data) to the display 20. The driver (not shown) of the display 20 subjects the image data to digital-analog conversion, and display the image data according to the converted analog signal. Therefore, the image data in which the OSD data has been combined is displayed on the display 20. As discussed above, the OSD data has the color data designated for each bit according to the display characteristics (i.e., the gamma curve) of the display 20. Also, the image data other than the OSD data is subjected to the gamma correction by the first image quality adjuster 13a. Therefore, the combined image data has its gradation values set corresponding to the display characteristics of the display 20. The processing of in the steps S5 and S6 or the controller 13 form output means of the present application.

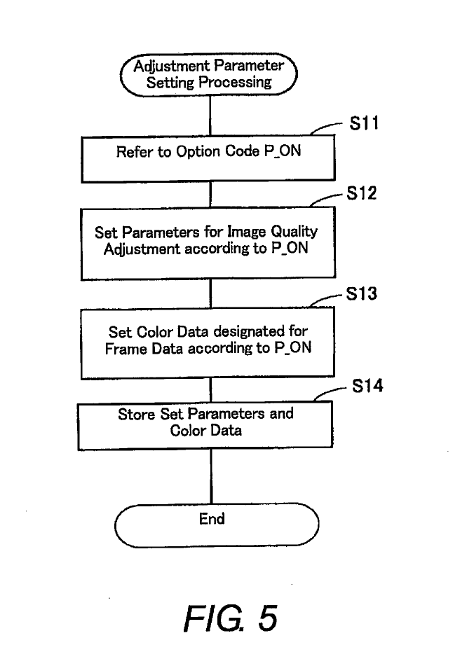

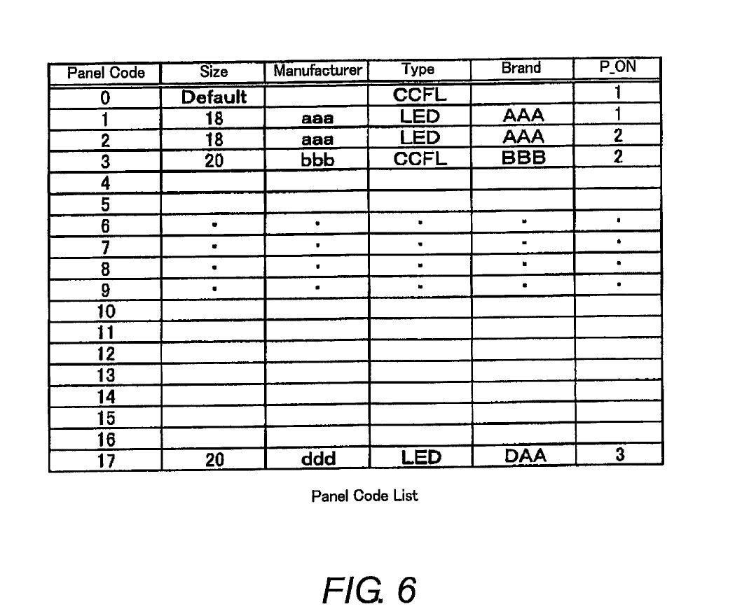

Next, the adjustment parameter setting processing executed by the display device 1 will be described through reference to FIG. 5. FIG. 5 is a flowchart illustrating adjustment parameter setting processing. This adjustment parameter setting processing sets the color data designated to the frame data that makes up the OSD data and parameters for the image quality adjustment executed in the image output processing. This adjustment parameter setting processing is also processing that is executed during an update of the firmware of the display device 1, for example. FIG. 6 is a diagram illustrating a panel code list recorded to the controller 13.

First, in step S11 in FIG. 5, the controller 13 decides whether or not the option code P_ON has changed. That is, the controller 13 refers to the option code P_ON and determines the type (e.g., display type) of the display 20, etc., to which the image data will be outputted.

The option code P_ON will be described referring to FIG. 6. The option code P_ON is a value set according to the type of the display 20 and the brand designated for the display device 1. For instance, the option code P_ON is recorded so that it is associated with a panel code list recorded to the controller 13. This panel code list is associated with a plurality of items, such as “size,” “manufacturer,” “backlight type,” and “brand.” The option code P_ON is decided by the combination of these items or by the panel code. For example, in FIG. 6, when a panel code 1 is specified to the display 20 to which the data will be outputted, an option code P_ON1, which is associated with an item combination of “18-inch,” “Company aaa,” “LED,” and “AAA,” is designated for the panel code 1. Therefore, the controller 13 refers to the panel code list after a firmware update, and determines the corresponding option code P_ON. The panel code list can also include other items or can only include relationship between the panel code and the option code P_ON.

In step S12, the controller 13 sets the parameters for image quality adjustment performed on the image data, according to the option code P_ON. The parameters for the image quality adjustment set in this step are the parameters used by the first image quality adjuster 13a. For instance, the controller 13 sets the various parameters for pixel count conversion processing and the gamma correction according to the value of the option code P_ON. The various parameters are recorded to the controller 13 in advance according to the image quality of the display 20 specified by the option code P_ON.

In step S13, the controller 13 selects the color data that constitutes the OSD data according to the option code P_ON. More specifically, the controller 13 selects the reference tables RLUT and color tables CLUT according to the option code P_ON, and thereby selects the color data according to the display characteristics of the display 20. Therefore, the controller 13 refers to a designation table 14a and selects the reference tables RLUT and color tables CLUT corresponding to the option code P_ON.

In this embodiment, the designation table 14a, which is used for referring to the color table CLUT corresponding to the option code P_ON, is recorded to the palette reference memory 14. In this designation table 14a are associated and recorded the option codes P_ON, the reference tables RLUT, and the color tables CLUT. For example, if there are three types of option code PON (“1” to “3”), then three types of reference tables RLUT1 to RLUT3 and color tables CLUT1 to CLUT3 are recorded and associated with each option code P_ON. Therefore, the controller 13 refers to this designation table 14a to select one of the reference tables RLUT and one of color tables CLUT based on the option codes P_ON.

In step S14, the controller 13 stores the parameters set in step S12 and the color data set in step S13 (i.e., the reference table RLUT and the color table CLUT) in the ROM, etc. The image quality adjustment of the image data is then performed by the first image quality adjuster 13a using the stored parameters, after which the OSD image is produced by the OSD component 13c using the stored color data. The color data constituting the OSD data and parameters for image quality adjustment executed in image output processing is set by the above adjustment parameter setting processing.

### Second Embodiment

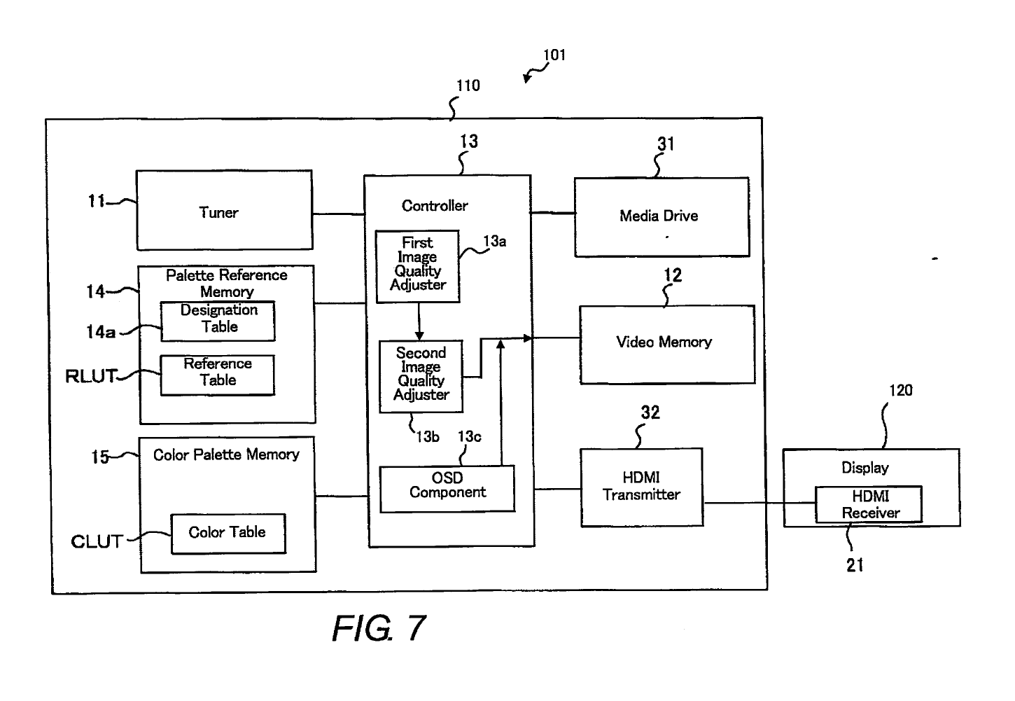

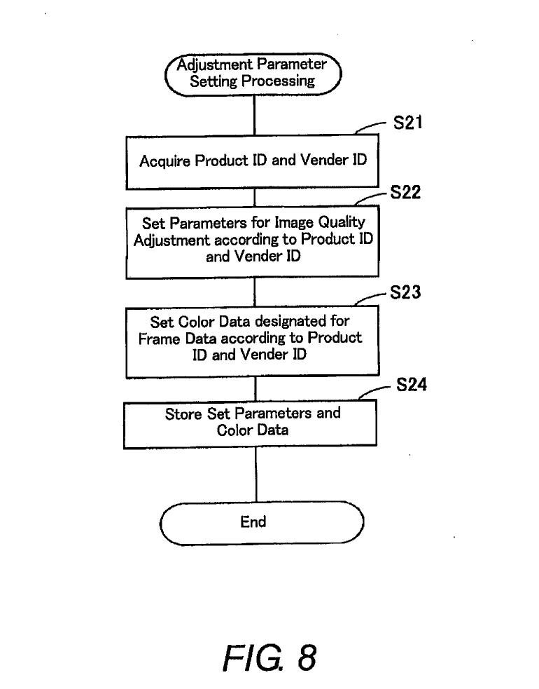

Referring now to FIGS. 7 and 8, an image output apparatus 110 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. FIG. 7 is a block diagram of the image output apparatus 110. FIG. 8 is a flowchart illustrating adjustment parameter setting processing of the image output apparatus 110.

The image output apparatus 110 is identical or functionally identical to the digital board 10 of the display device 1 of the first embodiment, except that the display characteristics of a target display apparatus 120 (e.g., a display apparatus or a display component) are acquired dynamically. In the illustrated embodiment, the image output apparatus 110 includes a video recording and reproduction device such as a media player. The image output apparatus 110 and the display apparatus 120 form a display system or device 101 (e.g., a display device).

As shown in FIG. 7, the image output apparatus 110 further includes a media drive 31 and an HDMI transmitter 32 in addition to the tuner 11, the video memory 12, the controller 13, the palette reference memory 14, and the color palette memory 15. The media drive 31 here is a circuit that reads or writes data from or to an optical medium. The HDMI transmitter 32 is connected to an HDMI receiver 21 provided to the display apparatus 120, and exchanges data according to the HDMI (High-Definition Multimedia Interface) standard. The configuration of the other components is the same as in the first embodiment. Thus, the detailed description of the components will be omitted for the sake of brevity.

The adjustment parameter setting processing will be described through reference to FIG. 8. First, in step S21, the controller 13 acquires the product ID (e.g., model ID) and vender ID (e.g., manufacturer ID) of the display apparatus 120 through the HDMI transmitter 32. The product ID here is an identifier for specifying the model of the display apparatus 120. The vender ID is an identifier for specifying the manufacturer of the display apparatus 120. In this embodiment, the image output apparatus 110 records the product ID and vender ID so that they are associated with a panel code list. Specifically, in the panel code list shown in FIG. 6, the product ID and vender ID take the place of the option code P_ON. The processing in this step S21 forms identifier acquisition means of the present application. For example, the controller 13 acquires the product ID and vender ID from the display apparatus 120 in response to connection with the display apparatus 120 via the HDMI standard. The controller 13 stores a plurality of combinations of product IDs and vender IDs as the panel code list in advance. Then, the controller 13 determines one of the combinations based on the acquired product ID and vender ID to determine display characteristics of the display apparatus 120.

In step S22, the controller 13 sets the parameters for image quality adjustment performed on the image data according to the product ID and vender ID. The parameters set in this step are used by the first image quality adjuster 13a. For example, the controller 13 sets various parameters for the pixel count conversion processing and the gamma correction according to the product ID and the vender ID. The relation between each ID and the parameters, etc., is as specified in advance such that a set of parameters for the image processing can be determined based on the pair of the product ID and the vender ID.

In step S23, the controller 13 sets the color data designated for the OSD frame data according to the product ID and vender ID. In this second embodiment, the product ID and the vender ID are recorded in association with the reference table RLUT and the color table CLUT in the designation table 14a. Thus, a pair of the reference table RLUT and the color table CLUT can be determined based on the pair of the product ID and the vender ID.

In step S24, the controller 13 stores the parameters set in step S22 and the color data set in step S23 (i.e., the reference table RLUT and the color table CLUT) in the ROM, etc. Therefore, image quality adjustment of the image data is then performed by the first image quality adjuster 13a using the stored parameters, after which the OSD image is produced by the OSD component 13c using the stored color data. The color data constituting the OSD data and parameters for the image quality adjustment executed in the image output processing is set by the adjustment parameter setting processing.

As described above, the display characteristics of the target display apparatus 120 are taken into account in the designation of the color data for the OSD data even when the OSD data is combined after the image data has undergone the image quality adjustment. Accordingly, consistent color can be attained even when the display characteristics are different between display apparatuses connected to the image output apparatus 110. Also, the color data assigned to each of the bits that make up the OSD data is designated using a color palette. Thus, the amount of information in the OSD data can be reduced.

With the image output apparatus (e.g., the digital board 10 or the image output apparatus 110) of the present application, the image output apparatus outputs image data to a display (e.g., the display 20 or the display apparatus 120). The image output apparatus has image quality adjustment means for subjecting the image data to specific image quality processing, OSD production means for producing OSD data that designates specific color data, according to display characteristics of the display to which the image data is outputted, and output means for combining the OSD data with the image data that has undergone the image quality processing, and outputting the result.

Furthermore, with the display device (e.g., the display device 1 or the display system 101) of the present application, the display device outputs image data to a display (e.g., the display 20 or the display apparatus 120) and displays an image. The display device has image quality adjustment means for subjecting the image data to specific image quality processing, OSD production means for producing OSD data that designates specific color data, according to display characteristics of the display to which the image data is outputted, and output means for combining the OSD data with the image data that has undergone the image quality processing, and outputting the result.

With the image output apparatus and the display device of the present application, the image quality adjustment means subjects the image data to the specific image processing. The OSD production means produces the OSD data that designates the specific color data, according to the display characteristics of the display to which the image data is outputted. The output means outputs the result of combining the OSD data with the image data that has undergone image quality processing.

Accordingly, even for the OSD data that is combined with the image data, the designation of the color data takes into account the display characteristics of the target display.

As a result, with the image output apparatus and the display device of the present application, consistent color can be achieved in the OSD image even when the image data is outputted to the displays with different display characteristics.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

It should be apparent to those skilled in the art that the present invention is not limited to the embodiments given above, but the following modification can be made without departing from the scope of the invention: suitably combining and changing the mutually interchangeable members, configurations, and so forth disclosed in the above embodiments; suitably substituting or combining and changing the interchangeable member, configuration, and so forth disclosed in the above embodiments with those that are not disclosed in the above embodiment but are conventionally known; and suitably substituting or combining and changing the member, configuration, and so forth that are not disclosed in the above embodiments with those that are apparent modifications to those skilled in the art based on the conventionally known technique as replacements for the member, configuration, and so forth disclosed in the above embodiment.

1. An image output apparatus comprising:
an image processing component configured to perform an image processing on input image data to generate processed image data;
an OSD production component configured to produce OSD data that specifies color data according to a display characteristic of a display apparatus that is configured to be connected to the image output apparatus; and
an output component configured to combine the OSD data with the processed image data to output output image data.

2. The image output apparatus according to claim 1, wherein
the OSD production component is configured to specify the color data based on an identifier identifying a display type of the display apparatus.

3. The image output apparatus according to claim 1, wherein
the OSD production component is configured to produce the OSD data by designating the color data corresponding to a gamma characteristic of the display apparatus.

4. The image output apparatus according to claim 1, further comprising
a memory component configured to store a color data group corresponding to a part of colors that is selected according to the display characteristic of the display apparatus from among the colors produced by display apparatus,
the OSD production component being further configured to produce the OSD data by utilizing the color data group.

5. The image output apparatus according to claim 1, further comprising
an identifier acquisition component configured to acquire an identifier identifying a display type of the display apparatus,
the OSD production component being further configured to determine the display characteristics of the display apparatus based on the identifier.

6. The image output apparatus according to claim 1, wherein
the image processing component is configured to perform the image processing on the input image data according to the display characteristic of the display apparatus.

7. The image output apparatus according to claim 1, further comprising
a memory component configured to store frame data that forms the OSD data with the frame data including a color ID associated with each pixel forming the frame data, and a reference table that associates the color ID with the color data according to the display characteristic of the display apparatus.

8. A display device comprising:
a display component;
an image processing component configured to perform an image processing on input image data to generate processed image data;
an OSD production component configured to produce OSD data that specifies color data according to a display characteristic of the display component; and
an output component configured to combine the OSD data with the processed image data to output output image data to the display component.

9. The display device according to claim 8, wherein
the OSD production component is configured to specify the color data based on an identifier identifying a display type of the display component.

10. The display device according to claim 8, wherein
the OSD production component is configured to produce the OSD data by designating the color data corresponding to a gamma characteristic of the display component.

11. The display device according to claim 8, further comprising
a memory component configured to store a color data group corresponding to a part of colors that is selected according to the display characteristic of the display component from among the colors produced by display component,
the OSD production component being further configured to produce the OSD data by utilizing the color data group.

12. The display device according to claim 8, further comprising
an identifier acquisition component configured to acquire an identifier identifying a display type of the display component,
the OSD production component being further configured to determine the display characteristics of the display component based on the identifier.

13. The display device according to claim 8, wherein
the image processing component is configured to perform the image processing on the input image data according to the display characteristic of the display component.

14. The display device according to claim 8, further comprising
a memory component configured to store frame data that forms the OSD data with the frame data including a color ID associated with each pixel forming the frame data, and a reference table that associates the color ID with the color data according to the display characteristic of the display component.
